(19) United States
(12) Patent Application Publication
(10) Pub. No.: US 2006/0097983 A1
(43) Pub. Date: May 11, 2006

(54) Tapping input on an electronic device

(75) Inventors: Kaj Haggman, Espoo (FI); Seppo Pyhalammi, Helsinki (FI); Jouni Soitinaho, Espoo (FI); Tuomo Sihvola, Espoo (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/970,995

(22) Filed: Oct. 25, 2004

(51) Int. Cl. G09G 5/00

(52) U.S. Cl. 345/156

(57) ABSTRACT

An apparatus and method for tapping input on electronic devices are provided. An electronic device, such as a phone, a media playing device, or a personal digital assistant, detects a tap by a user on a surface of the device using one or more motion sensors. Based on the data from the motion sensors, a location upon the surface of the device is determined, and based on that location, an action is performed. Tap input may be interpreted based upon a mode of operation of the device, orientation of the device, timing of the taps, or based on user-defined criteria. An attachable tapping template is provided which can be attached to an electronic device and share information about the template with the device using a radio frequency or electrical identifier.

### FIELD OF THE INVENTION

The invention relates generally to providing input to electronic devices, such as cellular telephones, portable music players, and similar devices. More particularly, the invention provides a method and apparatus for providing tactile input to electronic devices using motion sensors.

### BACKGROUND OF THE INVENTION

Electronic devices use a variety of input methods for users to control their functions. For example, input systems in portable phones may use mechanical buttons or touch screens where a user can enter a phone number or scroll through a menu. Personal digital assistants may use a pressure-sensitive hand-writing recognition system to give commands and enter text. Portable music players may use variants on a touch pad to select and play songs.

These input methods have been adapted over time to fit various form factors and interface needs, depending on the application. Designers have kept pace, miniaturizing and simplifying the interfaces. As the widespread use of these devices has grown, however, designers have begun to face new challenges. The reliability and usability of input systems like touch screens, touch pads, and even buttons has come into question, perhaps due to the overuse of moving parts, the lack of durable touch-sensitive surfaces (all of which continue to shrink in size) and the limited usability they provide.

As electronic devices have continued to shrink, they have simultaneously become more powerful and versatile. The convergence of personal digital assistants and mobile telephones has already become reality. In addition, many such devices allow users to play music or games, and also to take digital photos. This versatility comes at a price, however. Designers of these devices have had to stretch existing means of input, reusing buttons for three or more purposes. For example, the button representing the letter ‘E’ on a personal digital assistant may also represent the number ‘3,’ and the pound ‘#’ symbol, depending on the context of the input. There is potential for confusion among users as more functions are combined into smaller and fewer buttons.

Published U.S. application No. 2004/0169674 A1, entitled “Method for Providing an Interaction in an Electronic Device and an Electronic Device,” discloses a method for controlling an electronic device with a gesture of the hand holding the device. Three dimensional motion sensors within the electronic device detect a sequence of gestures in order to control the operation of the device. By merely tapping the device a particular number of times, a user can signal a command to the device.

While creating a new method for providing interaction with an electronic device, the method and device disclosed by the above-referenced published application are inadequate for addressing the broad interface needs of today's versatile electronic devices. The tapping “vocabulary” of the published application is realistically limited to the number of taps a user is willing to input before getting frustrated or losing count. It would be useful to have a larger “vocabulary” of tapping commands, and also to have greater flexibility for providing input to an electronic device using three-dimensional tactile commands, depending on the context within which the user is interacting with the device.

### SUMMARY OF THE INVENTION

A first embodiment of the invention presents a method of providing input to an electronic device. The method includes a step of detecting a tap by the user upon one of the surfaces of the device using one or more motion sensors. The tap can include a knock, or any other gesture by the user intended to provide input, as distinguished from unintentional jostling of the device. Based on data from the motion sensors, the location of the tap upon the surface of the device is determined, and based on the location that was tapped by the user, an appropriate action is performed.

A second embodiment of the invention provides an electronic device which includes one or more motion sensors and a processor. The processor is programmed with computer-executable instructions that detect a tap upon one of the surfaces of the device using data from the motion sensors. The processor determines the location of the tap upon the surface based on the data from the motion sensors and performs an action based upon the determined location.

A third embodiment of the invention provides an attachable tapping template which, on one side, displays visible markings delineating a location or multiple locations for a user to provide a tapped input. The tapping template also has a second surface adapted to attach to an electronic device. The template can attach using, for example, an adhesive, a snap or clasp, or some other attachment method. The template also includes one or more identifiers, e.g., radio frequency or galvanic contact electrical identifiers, which communicate to the device information about the template and its corresponding inputs.

### BRIEF DESCRIPTION OF THE DRAWINGS

FIG. 1 illustrates an electronic device including a plurality of motion sensors according to an illustrative embodiment of the invention.

FIG. 2 illustrates a block diagram of an illustrative embodiment of the invention.

FIG. 3 illustrates an electronic device including a plurality of locations for tapping on multiple surfaces of the device according to an illustrative embodiment of the invention.

FIG. 4A illustrates a flowchart of the steps that can be performed according to an illustrative embodiment of the invention.

FIG. 4B illustrates a flowchart of the steps that can be performed according to an illustrative embodiment of the invention.

FIG. 4C illustrates a flowchart of the steps that can be performed according to an illustrative embodiment of the invention.

FIG. 5 illustrates an attachable tapping template according to an illustrative embodiment of the invention.

FIG. 6 illustrates an electronic device with a tapping template attached on the front of the device according to an illustrative embodiment of the invention.

FIG. 7 illustrates an electronic device with a tapping template attached on the back of the device according to an illustrative embodiment of the invention.

FIG. 8 illustrates an electronic device with a tapping template attached on the back of the device according to an illustrative embodiment of the invention.

### DETAILED DESCRIPTION OF THE INVENTION

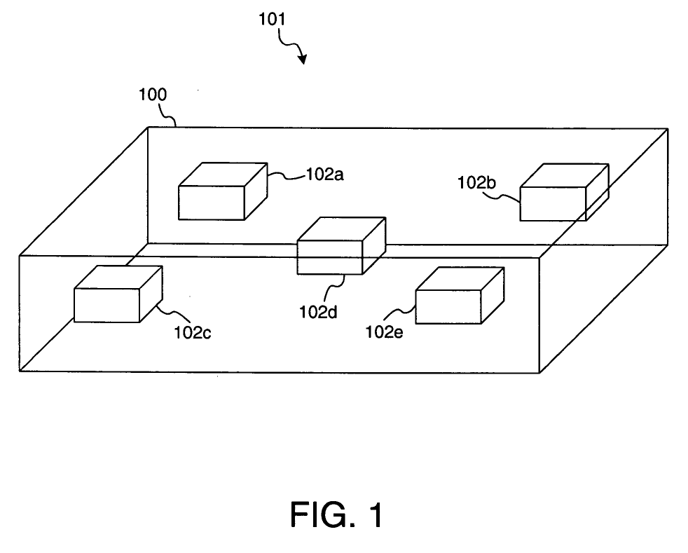

FIG. 1 illustrates an electronic device 101 according to an illustrative embodiment of the invention. The electronic device 101 may comprise a portable phone, a personal digital assistant, a media playing device, a music player, a video player, a digital camera, a television, a remote controller, a global positioning system (GPS) receiver, a wrist watch, a laptop computer, a portable memory unit such as a hard-drive device (HDD), a personal mobile server, or any combination of the above mentioned, or any other electronic device or mobile terminal having a processor and that receives some form of input from a user. The electronic device 101 of FIG. 1 comprises one or more motion, acceleration, position or combined sensors 102a-102e (collectively referred to herein as motion sensors 102) in a casing 100. Although the illustrated embodiment shows five such sensors, an electronic device can include as few as one, or up to an unlimited number (limited only by space), so long as the motion sensors 102 individually or collectively perform as described herein. The motion sensors 102 may individually be able to sense motion in only one or two directions, or may each be able to sense motion in all three dimensions. The motion sensors 102 may each comprise any form of acceleration or velocity transducer, accelerometer, position transducer, linear displacement sensor, distance or linear position sensors, or any other component which can interpret physical position, motion, or acceleration as a measurable quantity, such as electric potential. The motion sensors 102 may be placed anywhere inside or outside the casing 100, although placing multiple sensors throughout the device may permit more accurate measurements. More accurate measurements may be required if the device 101 uses a larger or more complex tapping interface or command structure, further described below. Some devices may already include a motion sensor for protecting a hard disk drive from sudden movement or impact, and these devices may also optionally use this motion sensor as described herein.

Using the motion sensors 102, electronic device 101 can detect tactile force input such as a user tapping on the casing 100. As used herein, tapping refers to the contact of a finger or other implement against the casing of the device 101, including a knock or any other contact that evidences an intention to strike the device in order to provide an input. Device 101 not only can detect whether input is in the X, Y, or Z dimension, or a combination of two or more of the X, Y, and Z dimensions, but can also detect where on the casing of the device 101 the tap occurred.

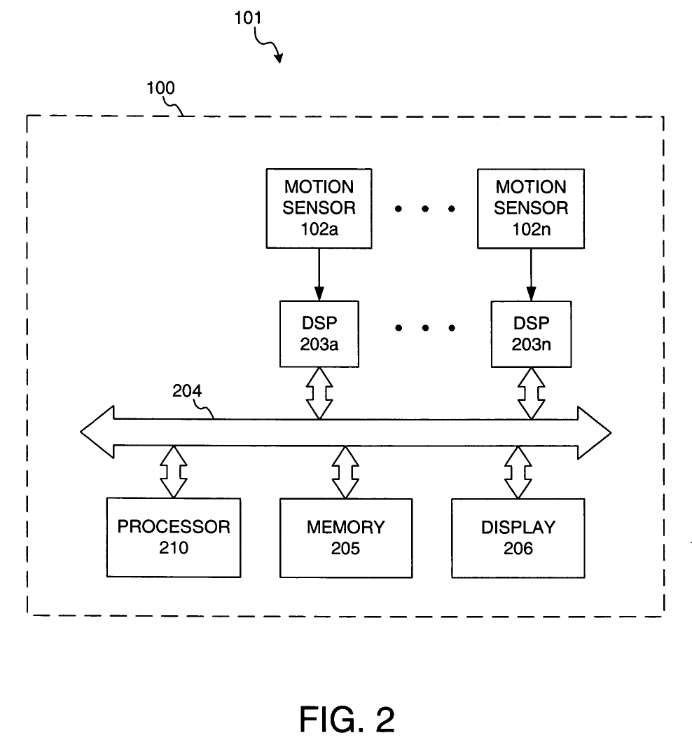

FIG. 2 illustrates a block diagram representing an illustrative embodiment of the electronic device 101. The device 101 comprises a processor 210, one or more motion sensors 102a-102n, one or more digital signal processors (DSPs) 203a-203n (collectively referred to herein as 203), corresponding to the one or more motion sensors 102, memory 205, a display 206, and a bus 204 through which the components communicate. The block diagram shown is an illustrative embodiment of the invention. Those of skill in the art will appreciate that additional components may be added and some components may be optional. For example, the electronic device 101 may also comprise or be connected to non-volatile memory such as a hard disk drive (with or without one or more motion sensors) or flash memory, input hardware such as a keypad, as well as communication components such as a wireless or a wired network interface. As another example, the function of the one or more DSPs 203 may be combined into a single DSP or integrated directly into the motion sensors 102. It should be noted that no direct connection between components is required, only that the components can communicate with each other to provide the functionality described herein. For example, the display 206 might not share the same bus 204 as the memory 205 and DSPs 203. The blocks in the diagram are intended to represent functional components, and some components might be combined or might be split into multiple components each providing a lower level of functionality.

A user can provide input to the electronic device 101 by tapping on the casing 100 of the device. As discussed above, tapping refers to the contact of a finger or other implement against the casing of the device 101, including a knock or any other contact that evidences an intention to strike the device in order to provide input. When a user taps the electronic device 101, the motion sensors 102 relay analog signals to the DSPs 203, which translate the analog values into appropriate digital values, which are then relayed to the processor 210 by way of the bus 204. Optionally, the digital values may be stored in memory 205 before being analyzed by the processor 210. The processor 210 determines whether there was a tap on the device 101, as opposed to simple jostling of the device. That is, when the motion sensors detect contact against the device 101, the contact may need to cause the one or more motion sensors 102 to meet or exceed a minimum threshold value or values before the sensed value is passed on for analysis. If a tap is detected, the processor 210 determines the location upon the surface of the device where the tap was delivered. Based on the location, the processor 210 selects and performs an action based on the input.

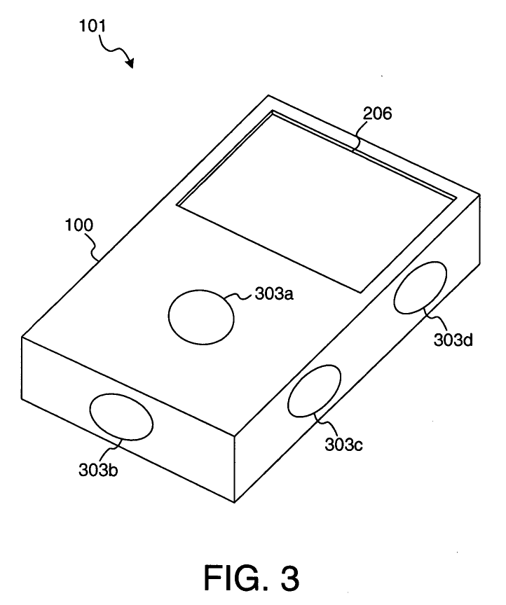

FIG. 3 illustrates a electronic device 101, comprising display 206, and several predefined tap locations 303a-303d, collectively referred to herein as 303, on multiple surfaces of the casing 100. The embodiment shown may be a mobile telephone, music player or portable video player, or any other electronic device. Each of the predefined tap locations 303 can be indicated in any number of ways on the casing 100 of the device 101, e.g., through permanent means such as printing, etching, or raised areas on a surface, or through temporary means such as stickers or attachable templates, further described below. A user may provide input to the device 101, for instance, to skip to a next song on a music player. To do this, the user may tap a predefined one of the side tap locations 303, e.g., 303d. Tapping on the front tap location 303a, for example, the user may play or pause a song. Tapping on the bottom location 303b, for example, the user may stop operation entirely. Other tap locations and functional assignments to tap locations may alternatively be used.

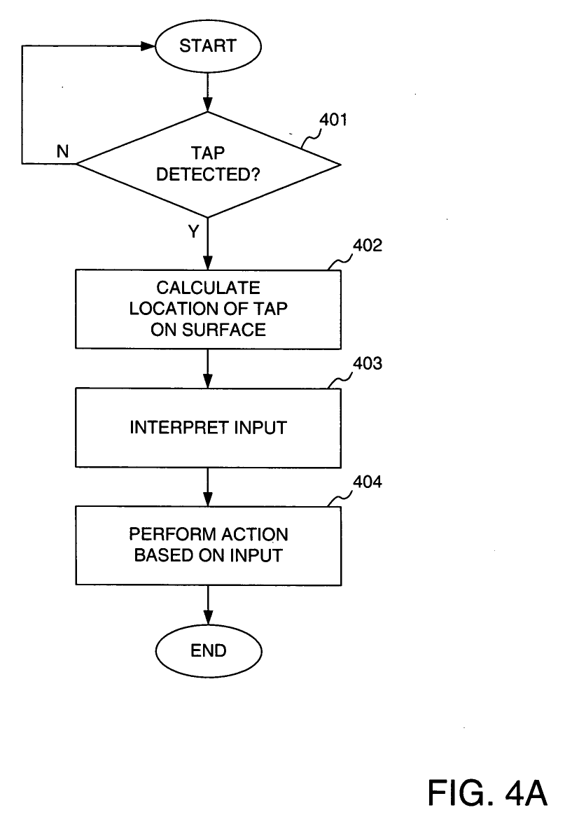

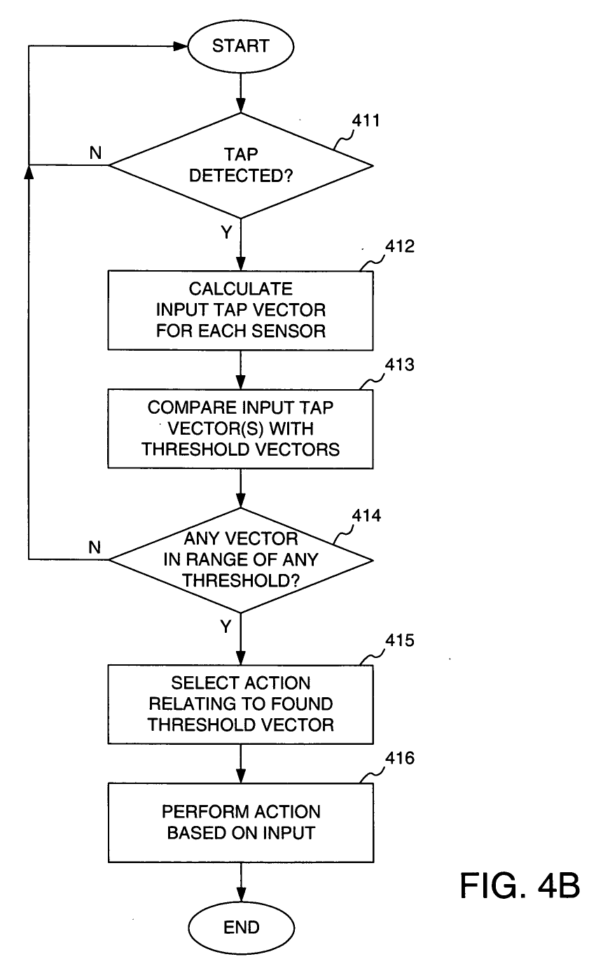

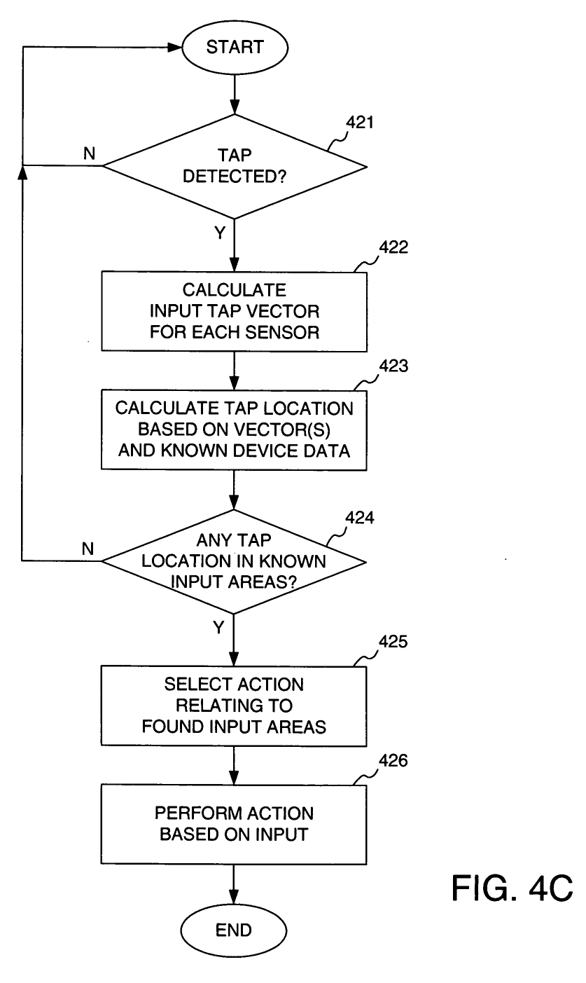

FIG. 4A illustrates a flowchart of steps that may be performed to interpret tactile input according to one or more embodiments of the invention. The illustrated steps are not intended to be exclusive, as other steps may be incorporated or combined, and some steps may be optional. Step 401 determines whether a tap has been detected on the surface of the electronic device. Here, the processor, receiving data from the motion sensors, will determine if the motion sensed was indeed a tap. If a tap is not detected then the device may wait for further input or resume normal operation. If a tap is detected, in step 402, the processor next calculates the location of the tap upon the surface of the device. Alternative methods for performing this calculation are disclosed below. In step 403, the processor interprets an input based on the location tapped. Finally, in step 404, the device performs an action based on the interpreted input.

FIGS. 4B and 4C illustrate two alternative illustrative methods that may be undertaken to perform an action in an electronic device according to one or more embodiments of the invention. FIGS. 4A-4C are not intended to represent the only methods by which an electronic device can perform an action based on a tapped input. As with FIG. 4A, additional steps may be incorporated or combined and some steps may be optional. In FIG. 4B, step 411 determines whether a tap has been detected on the surface of the electronic device. Referring back to FIG. 2, the detection of a tap is accomplished by one or more of the motion sensors 102, working with one or more DSPs 203 and processor 210. Processor 210 may be programmed to distinguish a tap from unintentional jostling of the device 101 using algorithms which analyze the motion sensor data against threshold values. Optionally, the DSPs 203 may be programmed to only pass on values which meet certain threshold requirements. If a tap is not detected, then the device may wait for further input or resume normal operation.

If a tap is detected in step 411, the tap data is passed on to step 412. Here, again referring back to FIG. 2, the one or more processors 210 analyze the force and direction of the tap as measured by the one or more motion sensors 102 and calculates an input tap vector corresponding to each motion sensor. In step 413, the processor may then compare the one or more input tap vectors to known threshold vector(s) having some specified meaning to determine a meaning of the tap and i.e. the location of the tap. If one or more of the input vectors correspond to one of the known threshold vectors at step 414, within an acceptable margin of error, then an action may be selected which relates to the one or more found threshold vectors in step 415. If no input vector correlates to any of the known threshold vectors, then the device may wait for further input or resume normal operation. Finally, in step 416, the action related to the input vector is performed. If more than one input vector and found threshold vectors are available, then the method and system may be more accurate at interpreting the desired action. The method may further refine the selection by requiring that some number of the total input tap vectors have been determined to have the same meaning. For example, if a device had three sensors and received three respective input vectors for a tap, then at least two of the three vectors may be required to have the same meaning in order to perform the corresponding action. Alternatively, the method may in step 412 calculate a composite input tap vector from the one or more input tap vectors and use it for comparison with the known threshold vectors.

As stated, FIG. 4C depicts an alternative method for performing an action in an electronic device according to one or more illustrative embodiments of the invention. Much like step 411 of FIG. 4B, step 421 determines whether a tap has been detected on the surface of the electronic device. If a tap is detected in step 421, the tap data may be passed to the processor in step 422 to determine the location of the tap on the casing 100 of the device 101. Again referring back to FIG. 2, this determination may be accomplished by the one or more processors 210 analyzing the force and direction of the tap as measured by the one or more motion sensors 102 and calculating an input tap vector corresponding to each motion sensor. In step 423, the location that was struck upon the casing 100 of the device 101 is determined based on the calculated input vector(s), coupled with data known about the device, possibly including the specific locations of sensor(s) within the device, and the dimensions of the device casing. By using the above mentioned data, it is possible to calculate a location where an input tap vector intersects the surface of the electronic device.

For step 424, if the location calculated does not fall within any known input areas on the casing of the device, i.e. within any threshold areas describing an action specific input area, then normal operation resumes, or the device may wait for additional input. However, if the location does fall within a known input area, then in step 425, the action associated with the found input area is selected, and in step 426, the action is performed. If more than one input vector and found threshold areas are available, then the method and system may be more accurate at interpreting the desired action. The method may further refine the selection by requiring that some number of the total input tap vectors have been determined to have the same meaning. For example, if a device had three sensors and received three respective input vectors for a tap, then at least two of the three vectors may be required to have the same meaning in order to perform the corresponding action. Alternatively, the method may in step 423 calculate a composite input tap vector from the one or more input tap vectors and use the intersection of the composite input vector with the surface of the device for comparison to the known threshold areas.

Accuracy of the location determination may be increased by comparing or combining the data collected from multiple motion sensors 102, i.e. multiple input tap vectors. In order to properly determine the location, it may be required for a user to run through an initial calibration routine, e.g., where the user taps on various surfaces, or locations on surfaces, of the device 101 in order to determine base values for specific locations and/or commands. Alternatively, the calibration routine may be performed by a manufacturer and calibrating vector values are implemented in a manufacturing process. This is based on fixed locations of sensors and tap input areas in the user device. If the location of a tap is indeterminable, the user may optionally be prompted to tap again, or the device may ignore the input. If the location of the tap has been determined, the device may optionally provide the user with audible, visual, and/or haptic feedback.

In another illustrative embodiment, the action selected in steps 415 or 425 may be interpreted based on the angle at which the device is oriented when input is received, based on the movement of the device before a tap, or based on input received from inclination sensors. For example, tapping an input while holding the device 101 level with the ground may be given a different meaning from tapping the device while holding it straight up and down. In selecting an action, a device 101 may also give meaning to movements of the device, whether along an axis of motion, or around an axis. For example, quickly moving device 101 in an upward direction may be interpreted to increase the volume in a media playing device or providing a positive rating to a song, whereas quickly moving the device in a downward direction may decrease the volume or provide a negative rating to a song. Quickly rotating the device 101 may also be interpreted as input, perhaps used to adjust the brightness or contrast of the display 206 of the device.

In another illustrative embodiment, the timing of successive taps upon a device 101 may additionally modify the input. For example, if the device 101 receives two successive taps in the same location, a shorter amount of time between taps may lead to the interpretation of a double tap, as differentiated from two slower single taps in the same location. Double tapping a particular location may lead the device to modify the action, for example, displaying an uppercase letter instead of the lowercase letter coinciding with the location on the device 101. Moreover, the number of taps within a particular period of time may further modify the intended input, allowing for unlimited multi-tap schemes, as further demonstrated below.

In yet another illustrative embodiment, an electronic device 101 may select an action based on multiple modes of operation of the device. A device 101 may interpret a particular tap input to mean different things depending on the current mode of operation. For example, device 101 such as a music player may have a normal mode of operation in which inputs are interpreted in a default manner expected by users of the device, e.g., using tap locations 303 as described above with respect to FIG. 3. However, in an alternative mode of operation such as pocket, jogging, biking, or car driving mode, the device 101 may modify the interpretation of taps. For example, a single tap at a specific location 303a of the casing 100 of the device 101 shown in FIG. 3 may pause a song while in a media player mode of operation, but may hang up a telephone call while in a telephone mode of operation. Additionally, for a music player, a tap which was interpreted to play a song in normal mode, in song rating mode may be interpreted as a rejection of the current song's rating.

In another example, a first mode of operation may allow a user to provide more dexterous inputs than a second mode of operation. In the first mode of operation, the user may provide input using any tap location 303 (FIG. 3), or other defined tap location, whereas in the second mode of operation the taps may be interpreted independent of their specific location on the case 100, and instead device 101 may interpret the tap based only on a number of taps received or only on the side of the case that is tapped by the user, or a combination of the two, thus ignoring the specific location on the side of the case that is tapped by the user. This is useful when a user does not have as fine motor control as a default mode of operation requires, e.g., while jogging, biking, or performing any other distracting activity. Additional modes may further expand the available commands for a device 101.

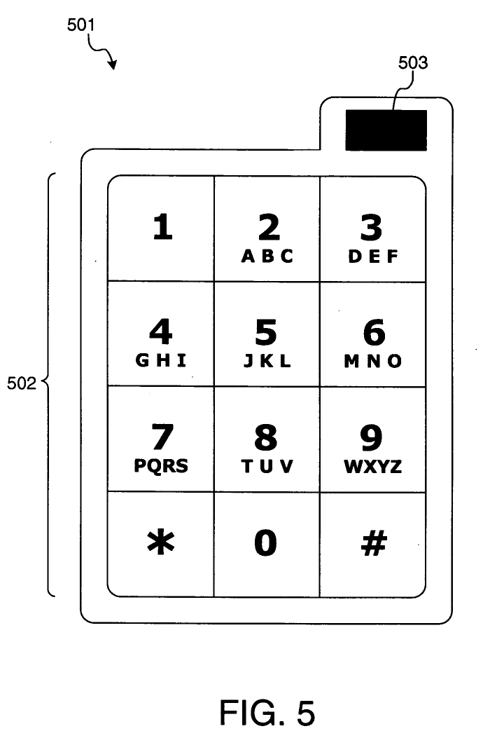

In still another illustrative embodiment, with further reference to FIG. 5, electronic device 101 may select an action based on a tapping template attached to the device 101. That is, electronic device 101 may use adaptable rather than fixed tap locations. FIG. 5 illustrates a tapping template 501 that may be used with device 101. The tapping template 501 contains a plurality of tapping locations 502, although there can be as few as one tapping location on a particular tapping template. In the present example, the tapping locations 502 of the tapping template 501 correspond to keys of a typical keypad for a telephone, although these “keys” are merely painted or printed onto a flat template. The tapping template 501 may be adapted to attach to an electronic device, e.g., using an adhesive, magnetism, clasps, or any other mechanism or method for securely attaching. The tapping template 501 may comprise a device-specific rigid cover, such as a plastic or metal cover, for covering a portion of an electronic device 101. Alternatively, the tapping template 501 may be adapted on a carrying case, a carrying bag, or a protective casing of an electronic device 101. The attachable tapping template 501 may comprise an identifier 503 such as a passive RFID device or tag, which can wirelessly provide information about the tapping template to the device to which it is attached.

Alternatively, the tapping template 501 may have an active RFID device, tag or reader. Further, the tapping template 501 may include a memory device or chip (not shown), one or more motion sensors (not shown) and an electric source, such as a battery for powering the memory (not shown), sensors, a processor, and/or the identifier. The sensors and processor in the template 501 may be used to determine the input tap vector, especially if the device 101 does not have its own sensors, and to communicate to the device 101. Furthermore, the identifier 503 may comprise a Bluetooth, ultra wide band (UWB), or any other short range radio communication component.

In the above mentioned embodiments, the device 101 comprises a corresponding component for communicating with the tapping template 501, such as an RFID reader, a Bluetooth component, a UWB component, or other wireless connection. However, the tapping template may be used as such without any included electronic components.

The information provided by the identifier 503 may include vector information and resulting commands for interpreting tap input using the template, software controlled by the template, a template title, or other instructions. The provided information may differ depending on the device type, as detected by a RFID or other wireless device, such that the provided information is suitable for the device to which the template is attached. Information may also be provided from the device 101 to the template 501 and may be stored in the template. This information may comprise, for example, device or user identification, authentication information, digital rights management information, and/or user specific template calibration information. Alternatively, the device 101 and tapping template 501 may have one or more galvanic contact points which, when electrically connected to the identifier 503 on a tapping template 501, receive information about the template into the device 101 and/or supply electricity to the tapping template. In addition to basic information about the template 501, the identifier 503 may provide software instructions for how the device utilizes the tapping locations 502 outlined by the tapping template.

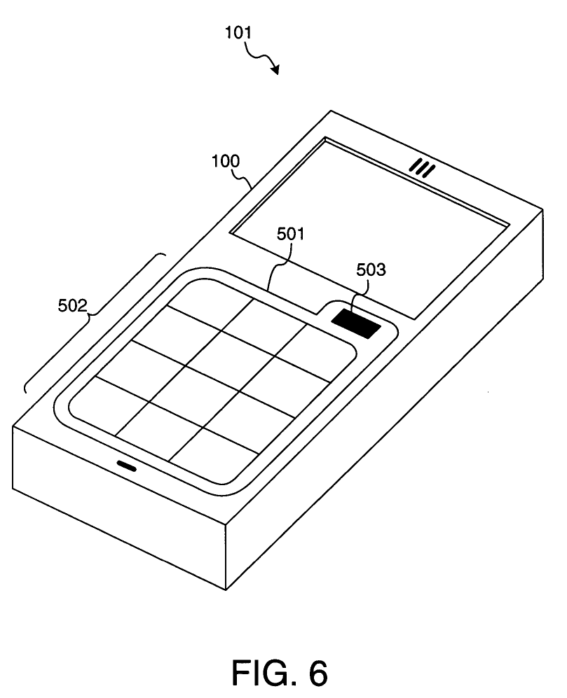

FIG. 6 shows an illustrative embodiment of an attachable tapping template 501 attached to an electronic device 101. Here, the device 101 has a portable telephone mode of operation. The attached tapping template 501 may have tapping locations for the numbers of a telephone keypad, perhaps identified with Western numerals. Alternatively, a user or manufacturer can swap out the Western numeric template for an Arabic numeric template, or other foreign language template. The identifier 503 passes information about the attachable tapping template 501 to the device 101. A device 101 may additionally provide device specific information to the identifier 503 by sending its device identifier or specifications to the identifier. This information may be passed by way of an RFID reader within the device 101, or via electrical contacts on the casing 100 of the device. In the above example, in addition to providing information about the characters on the template, the identifier 503 may also pass information about the language of the template, and provide software enabling the device 101 to display Arabic characters. A user wishing to play a game on the device 101 can switch the tapping template 501 with a different game-specific template (not shown). Each time a new tapping template 501 is attached, the device 101 receives information about the template from its identifier 503. In the case of an application-specific template, one that is game-specific for example, the identifier 503 may be able to provide the application itself to the device.

In an alternative embodiment, a user might override a tap location defined by the identifier 503, and may manually map one or more undefined input locations to perform certain actions designated by the user. In yet another alternative embodiment, an attachable template might not include an identifier 503, and instead the user can manually map one or more input locations to perform certain actions designated by the user. An example of such a template might include a sticker placed on the device 101 by the user, and assigned a pre-defined function by the user, such as “Call Mom.” Another example might include a sticker that acts as a camera shutter button, where the user desires to determine where on the device 101 the shutter button should be located to be most convenient for that user. In these embodiments, the device 101 may need to be taught to recognize the input location and related command(s).

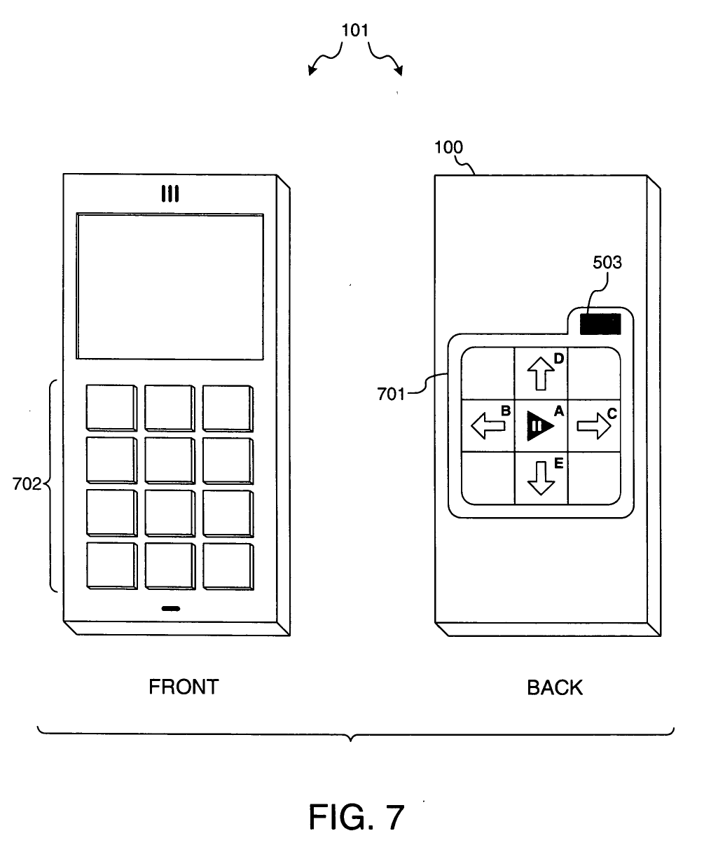

FIG. 7 illustrates another variation of an attachable tapping template 701 or fixed tapping template (see FIG. 3) attached to an electronic device 101. The device 101 may again include a portable telephone function, but instead of replacing the integrated button keypad 702 on such devices, the tapping template 701 supplements the keypad and may be attached on the back or any side of the device 101. Alternatively, the tapping template 701 may have one or more parts having one common or many separate identifiers 503. Here, the tapping template 701 may be used to control a music or video player application within the device 101. Once the tapping template 701 has been attached to the casing 100 and the identifier 503 has passed information about the template to the device 101, the device can select an action based on tapped input in any number of ways, taking into account the orientation and motion of the device, the mode of operation, as well as the timing and quantity of taps, as previously described. As an example of how taps upon the template 701 may be interpreted for a music playing application, the following illustrative table of commands may be used:

| Location | Taps | | Action |
|---|---|---|---|
| A | 1 | Tap | Play |
| | 2 | Taps | Pause - Stop |
| | 3 | Taps | Shuffle - Random Play |
| B | 1 | Tap | Same Song from Beginning |
| | 2 | Taps | Previous Song |
| | 3 | Taps | Start of Playlist or Album |
| C | 1 | Tap | Next Song |
| | 2 | Taps | Song After Next Song |
| | 3 | Taps | Next Playlist or Album |
| D | 1 | Tap | Volume Up |
| E | 1 | Tap | Volume Down |

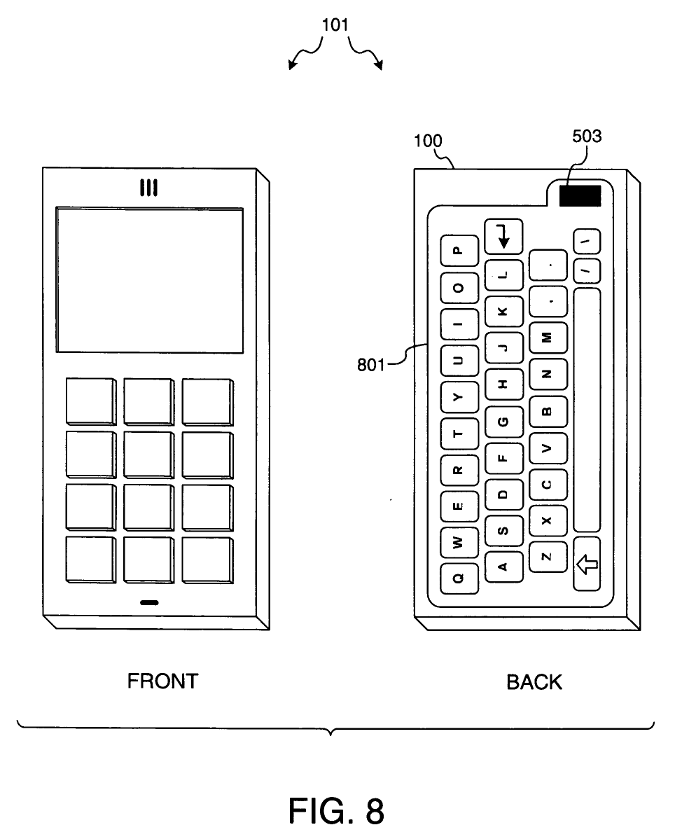

FIG. 8 illustrates an embodiment of the invention with a different tapping template 801 attached. Here, the tapping template 801 provides an alphanumeric keyboard layout, perhaps for use with an email or instant messaging application within the device 101. When a user swaps the tapping template 701 of FIG. 7 for the template 801 of FIG. 8, the identifier 503 on template 801 informs the device 101 as to the new template's layout, functions, commands, and/or identity.

When a template is attached to device 101, the user may need to calibrate the device 101 initially by running through a series of taps, e.g., tapping each predefined input location so the device can sense the resultant motion sensor values. This may be needed if sensor locations and/or the location of the template are not fixed. In general, if the tapping template is attached to a specific device at a previously determined specific location, there may not be a need to teach the location(s) for tapping inputs to the device 101. Calibration may also be performed for permanent input locations. Optionally, the device 101 may automatically switch to an application related to an attached template based on the identity of the template being attached as identified by its identifier.

Using attachable templates a user can continuously upgrade an electronic device with new input interfaces simply by attaching a new template to the device. Users may detach templates and move them to other devices without requiring the user to purchase separate templates for each device.

While the invention is particularly useful in portable electronic devices having limited input controls, the invention may be used in conjunction with any electronic device have any number of input controls, limited only by the ability of the internal sensors to detect tap input. While the invention has been described with respect to specific examples including presently preferred modes of carrying out the invention, those skilled in the art will appreciate that there are numerous variations and permutations of the above described devices and techniques that fall within the spirit and scope of the invention as set forth in the appended claims. For example, features described relating to the attachable templates and to determining locations of the inputs are applicable reciprocally between the template and the device.

We claim:

1. A method of providing input to an electronic device, comprising steps of:
(1) detecting by one or more motion sensors a tap upon a surface of the electronic device;
(2) determining a location of the tap upon the surface based on data from the one or more motion sensors; and
(3) performing an action based on the location of the tap.

2. The method of claim 1, wherein step (2) comprises determining a location of the tap by comparing one or more input tap vectors with one or more threshold tap vectors.

3. The method of claim 2, wherein each of the one or more threshold tap vectors relate to a specific command.

4. The method of claim 2, wherein the one or more input tap vectors are determined based on signals from the one or more motion sensors.

5. The method of claim 1, wherein step (2) comprises determining the location of the tap based on:
one or more input tap vectors;
locations of the one or more sensors within the device; and
dimensions of the electronic device.

6. The method of claim 1, wherein step (3) comprises determining the action by comparing the location of the tap with one or more input areas.

7. The method of claim 6, wherein the input area defines the action.

8. The method of claim 1, wherein step (2) comprises determining a location of the tap to be in a predefined location upon the surface.

9. The method of claim 8, wherein step (2) comprises selecting the predefined location from a plurality of predefined locations.

10. The method of claim 9, wherein step (2) further comprises selecting the predefined location from a plurality of predefined locations corresponding to keys of a numeric keypad.

11. The method of claim 9, wherein step (2) further comprises selecting the predefined location from a plurality of predefined locations corresponding to keys of an alphanumeric keyboard.

12. The method of claim 9, wherein step (2) further comprises selecting the predefined location from a plurality of predefined locations corresponding to predefined commands.

13. The method of claim 8, wherein step (2) comprises determining a location of the tap to be in a predefined location upon an attached tapping template.

14. The method of claim 1, wherein step (2) comprises determining which surface among a plurality of surfaces of the electronic device received the tap.

15. The method of claim 1, wherein step (2) comprises the one or more motion sensors collectively detecting motion in three physical dimensions.

16. The method of claim 1, wherein step (2) comprises each of the one or more motion sensors detecting motion in three physical dimensions.

17. The method of claim 1, wherein step (2) comprises determining a location of the tap based on force data corresponding to the tap.

18. The method of claim 1, wherein step (2) comprises determining a location of the tap based on direction data corresponding to the tap.

19. The method of claim 1, wherein step (3) comprises performing an action based on the location of the tap and based on an angle at which the device is situated.

20. The method of claim 1, wherein step (3) comprises performing an action based on the location of a tap and based on an amount of time since a previous tap.

21. The method of claim 1, wherein step (3) comprises performing an action based on a direction of movement of the device.

22. The method of claim 1, wherein step (3) comprises performing an action based on the location of the tap and based on a template attached to the device.

23. The method of claim 1, wherein step (3) comprises performing an action based on the location of the tap and based on a mode of operation of the electronic device.

24. An electronic device comprising:
one or more motion sensors; and
one or more processors programmed with computer-executable instructions that, when executed, perform the steps of:
(1) detecting by the one or more motion sensors data about a tap upon a surface of the electronic device;
(2) determining a location of the tap upon the surface based on the data; and
(3) performing an action based upon the location of the tap.

25. The device of claim 24, further comprising a digital signal processor corresponding to each of the one or more motion sensors.

26. The device of claim 24, wherein each of the one or more motion sensors are capable of detecting motion in three physical dimensions.

27. The device of claim 24, wherein the surface of the electronic device includes visible markings delineating one or more locations for tapping.

28. The device of claim 24, wherein the electronic device comprises a portable phone.

29. The device of claim 24, wherein the electronic device comprises a media playing device.

30. The device of claim 24, wherein the electronic device comprises a personal digital assistant.

31. The device of claim 24, wherein step (2) of the computer-executable instructions comprises determining a location of the tap to be in a predefined location upon the surface.

32. The device of claim 24, wherein step (2) of the computer-executable instructions comprises determining a location of the tap to be in a predefined location upon an attached tapping template.

33. The device of claim 24, wherein step (2) of the computer-executable instructions comprises determining a location of the tap by comparing one or more input tap vectors with one or more threshold tap vectors.

34. The device of claim 33, wherein each of the one or more threshold tap vectors relate to a specific command.

35. The device of claim 24, wherein step (2) of the computer-executable instructions comprises determining a location of the tap based on:
one or more input tap vectors;
locations of the one or more sensors within the device; and
dimensions of the electronic device.

36. The device of claim 24, wherein step (2) of the computer-executable instructions comprises determining which surface among a plurality of surfaces of the electronic device received the tap.

37. The device of claim 24, wherein step (2) of the computer-executable instructions comprises the one or more motion sensors collectively detecting motion in three physical dimensions.

38. The device of claim 24, wherein step (3) of the computer-executable instructions comprises performing an action based on the location of the tap and based on an angle at which the device is situated.

39. The device of claim 24, wherein step (3) of the computer-executable instructions comprises performing an action based on the location of the tap and based on an amount of time since a previous tap.

40. The device of claim 24, wherein step (3) of the computer-executable instructions comprises performing an action based on a direction of movement of the device.

41. The device of claim 24, wherein step (3) of the computer-executable instructions comprises performing an action based on the location of the tap and based on a mode of operation of the electronic device.

42. An attachable tapping template comprising:
a surface displaying visible markings delineating one or more locations for tapping by a user;
a second surface adapted to attach the template to an electronic device; and
one or more identifiers adapted to communicate to the electronic device information about the tapping template.

43. The attachable tapping template of claim 42, further comprising an adhesive to attach the template to the electronic device.

44. The attachable tapping template of claim 42, wherein the attachable tapping template comprises a rigid attachable cover for the electronic device.

45. The attachable tapping template of claim 42, wherein the one or more identifiers comprise a passive RFID device.

46. The attachable tapping template of claim 42, wherein the one or more identifiers comprise one or more electrical contacts for communicating with the electronic device.

47. The attachable tapping template of claim 42, wherein the identifier comprises control instructions dependent on a device type.

48. The attachable tapping template of claim 42, wherein the identifier comprises software controllable by the attachable tapping template.

49. A system for performing an action based on an input, the system comprising:
a tapping template including visible markings delineating one or more locations for tapping by the user; and
an electronic device attached to the tapping template, and containing one or more motion sensors, wherein the device is adapted to detect a tap upon a surface of the template, determine a location of the tap upon the surface of the template, and perform an action based upon the location of the tap.

50. The system of claim 49, wherein the electronic device comprises a phone.

51. The system of claim 49, wherein the electronic device comprises a portable music player.

52. The system of claim 49, wherein the electronic device comprises a personal digital assistant.

53. The system of claim 49, wherein the attachable tapping template includes one or more identifiers adapted to communicate to the electronic device information about the tapping template.

54. The system of claim 53, wherein the one or more identifiers comprise an RFID tag.

55. The system of claim 54, wherein the electronic device comprises one or more RFID readers.

56. A mobile terminal comprising:
one or more delineated locations for tapping on a surface of the mobile terminal;
one or more motion sensors that sense a tap upon the surface of the mobile terminal;
an action performing function that receives data about the sensed tap from the motion sensors, determines the location of the tap upon the surface of the mobile terminal, selects and performs an action based on the location of the tap.

57. The mobile terminal of claim 56, further comprising an attached tapping template for providing the delineated locations for tapping.
